(19) United States
(12) Patent Application Publication
(10) Pub. No.: US 2009/0284692 A1
(43) Pub. Date: Nov. 19, 2009

(54) DISPLAY DEVICE AND METHOD THEREOF

(75) Inventors: Hyo-Sang YANG, Yongin-si (KR); Dong-Wan CHOI, Seoul (KR); Hee-Kwon EUN, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/394,210

(22) Filed: Feb. 27, 2009

(30) Foreign Application Priority Data
May 19, 2008 (KR) 1020080046192

(51) Int. Cl. G02F 1/1335

(52) U.S. Cl. 349/95

(57) ABSTRACT

A display device includes a display panel including a display area and a non-display area defined therein, and a protective substrate disposed on a viewing side of the display panel. At least one light receiving element is provided in the non-display area, and a focusing pattern is disposed on the protective substrate corresponding to a location at which the light receiving element is disposed.

This application claims priority to Korean Patent Application No. 10-2008-0046192 filed on May 19, 2008, and all the benefits accruing therefrom under 35 U.S.C. §119, the disclosure of which is incorporated herein by reference in its entirety.

### BACKGROUND OF THE INVENTION

1. Field of the Invention

The present invention relates to a display device, and more particularly, to a display device having improved sensitivity of a light receiving element by providing a focusing pattern in front of a display panel including the light receiving element.

2. Description of the Related Art

Liquid crystal displays capable of displaying images by controlling transmittance of light incident from a light source using optical anisotropy of liquid crystals and polarizing properties of a polarizing plate, have some notable advantages, such as lightness, thin profile, compact size, superior resolution, large screen size, and low power consumption, and have recently been used in a wide variety of applications.

A liquid crystal display includes an upper substrate having black matrixes, color filters, and a common electrode, a lower substrate having thin film transistors (“TFTs”), and a plurality of pixel electrodes, and a liquid crystal layer disposed between the two substrates. Liquid crystal material injected between the two substrates is driven by electric fields formed between the common electrode and the pixel electrode, thereby controlling the transmittance of incident light to display images. Meanwhile, a liquid crystal display does not emit light by itself and provides back light to a display panel.

Brightness of an image displayed on the liquid crystal display is determined by the luminance of back light. Unduly high luminance of a displayed image, compared to the illuminance of external light, may cause glare, and too low luminance may be detrimental to readability. Thus, it is necessary to actively adjust the luminance of back light according to the external illuminance.

Accordingly, in order to secure the competitiveness of liquid crystal display products, liquid crystal displays are being developed in structures incorporating a light receiving element detecting external light at an exterior side of a display region displaying an image, and increasing or decreasing the luminance of a back light using information about the illuminance or luminance detected by the light receiving element, thereby adjusting the luminance of the image displayed on the display region according to the external light.

### BRIEF SUMMARY OF THE INVENTION

Since liquid crystal displays may include structures incorporating a light receiving element detecting external light at an exterior side of a display region displaying an image, there may be cost disadvantages in employing the light receiving element, or the light receiving element may have relatively poor sensitivity. For example, since high-sensitivity light receiving elements are expensive, intermediate- and low-cost light receiving elements, which are, however, poor in sensitivity, are generally employed for mass production. Poor sensitivity of a light receiving element may render a problem. Furthermore, in a case where the illuminance of the ambient condition is low or the illuminance of the ambient condition gradually changes, a poor-sensitivity light receiving element may not be able to detect a slight change in the illuminance.

An exemplary embodiment provides a display device with improved sensitivity of a light receiving element by providing focusing patterns in front of the light receiving element.

An exemplary embodiment provides a display device with improved sensitivity while reducing a manufacturing cost by employing intermediate- and low-cost, relatively less sensitive light receiving elements.

An exemplary embodiment provides a display device with improved display quality by actively controlling luminance of back light according to external illuminance while reducing power consumption.

The above and other objects of the present invention will be described in or be apparent from the following description of the exemplary embodiments.

In an exemplary embodiment, there is provided a display device including a display panel including a display area and a non-display area defined therein, and a protective substrate disposed on a viewing side of the display panel. At least one light receiving element is provided in the non-display area. A focusing pattern is disposed on the protective substrate corresponding to a location at which the light receiving element is disposed.

In an exemplary embodiment there is provided a display device including a display panel including a display area and a non-display area defined therein, a light measuring unit including at least one light receiving element provided in the non-display area, a protective substrate disposed on a viewing side of the display panel and including a focusing pattern provided at a predetermined region where the light receiving element is disposed, and a light-emitting block supplying back light to the display panel, such that the luminance of the back light is adjusted in response to the external illuminance sensed by the light receiving element.

In an exemplary embodiment, there is provided a method of forming a display device. The method includes disposing a light receiving element in a non-display area of a display panel, disposing a protective substrate on a viewing side of the display panel, and providing a light-emitting block supplying back light to the display panel. The light receiving element senses an illuminance from external to the display panel and has a light receiving axis. The protective substrate includes a focusing member disposed corresponding to the light receiving axis of the light receiving element, collects the external illuminance and provides the collected external illuminance to the light receiving element. The luminance of the back light is adjusted in response to the external illuminance sensed by the light receiving element.

### BRIEF DESCRIPTION OF THE DRAWINGS

The above and other features and advantages of the present invention will become more apparent by describing in detail exemplary embodiments thereof with reference to the attached drawings in which:

FIG. 1 is a plan view of an exemplary embodiment of a display panel included in a display device according to the present invention;

FIG. 2 is a cross-sectional view of an exemplary embodiment of a display panel corresponding to a unit pixel shown in FIG. 1;

FIG. 3 is a cross-sectional view of a display panel, taken along line I-I′ of FIG. 1;

FIGS. 4 through 8 illustrate exemplary embodiments of focusing patterns according to various modifications of the invention shown in FIG. 3;

FIGS. 9 and 10 are perspective and partial cross-sectional views illustrating exemplary embodiments of focusing patterns according to various modifications of the invention;

FIGS. 11 and 12 are partial cross-sectional views illustrating exemplary embodiments of focusing patterns according to various modifications of the invention;

FIG. 13 is a block diagram of an exemplary embodiment of a display device including the display panel and a protective substrate according to the present invention illustrated with reference to FIGS. 1 through 12; and

FIG. 14 is an exemplary embodiment of a circuit diagram illustrating a backlight driver and a light-emitting block shown in FIG. 13.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification. As used herein, the term “and/or” includes any and all combinations of one or more of the associated listed items. In the drawings, the size and relative sizes of layers and regions may be exaggerated for clarity.

It will be understood that when an element or layer is referred to as being “on”, “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

In the following, a display device will be described with regard to a liquid crystal display by way of example, however the present invention is not limited thereto. Rather, the present invention can be applied to any display device as long as it may be provided with a protective substrate in front of a display panel including a light receiving element. In exemplary embodiments, the present invention can be applied to various display devices, including but not limited to, an organic light emitting diode (“OLED”), plasma display panel (“PDP”), and the like.

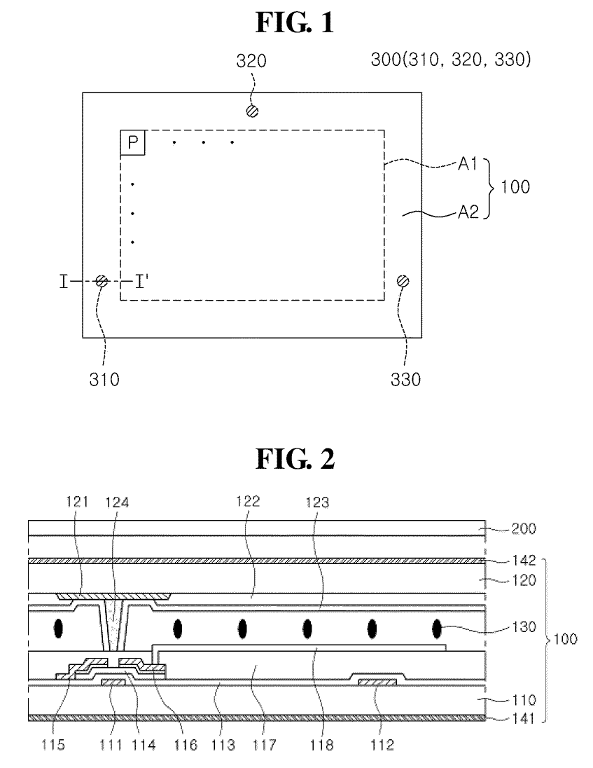

FIG. 1 is a plan view of an exemplary embodiment of a display panel included in a display device according to the present invention.

In the following, a display panel will be described with regard to a display panel 100 by way of example, however the present invention is not limited thereto.

Referring to FIG. 1, the display panel 100 includes a display area A1 on which images are displayed, and a non-display area A2 adjacent to the display area A1 on which no images are displayed. A plurality of pixels P displaying one of three primary colors, i.e., red, green and blue, may be arranged in the display area A1. A driving circuit (not shown) for controlling the pixels P provided in the display area A1, and at least one light receiving element 300 (310, 320, 330), for improving an image display function and providing additional functions, may be provided in the non-display area A2.

The light receiving element 300 receives external light to convert the same into an electric signal, and various additional functions can be offered based on the light receiving element 300. As used herein, “external light” may be defined as light not generated within the display panel 100, such as natural light or ambient light from an environment outside of all elements of the display panel 100.

In the illustrated embodiment, the light receiving element 300 is provided for the purpose of actively controlling the luminance of images to be displayed adaptively to the ambient condition in which the display panel 100 is installed. The display panel 100 is a non-emitting device, and may use external light to allow a user to easily recognize the images displayed on the display panel 100. In exemplary embodiments, a transmissive display panel is provided with a light source disposed in a rear of the display panel in order to display images, while a reflective display panel is provided with a light source disposed in front of the display panel, e.g., at a viewing side of the display panel.

The luminance of the images displayed in the liquid crystal display may be determined by the luminance of incident light. Where a transmissive display panel is employed in a display device, the luminance of incident light may be controlled by identifying luminance of the ambient condition using the light receiving element 300. The light receiving element 300 may be used not only for controlling the luminance of the images to be displayed, but may also provide additional functions in the display device. In one exemplary embodiment, the light receiving element 300 can also be used for sensing a touch and/or image scan.

In an exemplary embodiment, the light receiving element 300 is preferably disposed in the non-display area A2 of the display panel 100, so as not to interfere with images being displayed in the display area A1. An exemplary embodiment of the light receiving element 300 includes, but is not limited to a photo diode. In addition, the light receiving element 300 may be plurally provided at a substantially uniform distance throughout the entire area of the non-display area A2, so as to accurately detect the luminance of the ambient condition.

In the illustrated embodiment, a first light receiving element 310, a second light receiving element 320 and a third light receiving element 330 are provided at three locations of the non-display area A2, these locations being arranged around the display area A1. In one exemplary embodiment, the luminance of the images to be displayed may be controlled by averaging the luminance data detected by the first, second and third light receiving elements 310, 320 and 330.

The display panel 100 may include two longitudinal edges and two transverse edges substantially perpendicular to both of the longitudinal edges. While the first, second and third light receiving elements 310, 320 and 330 are disposed substantially centered in a the non display area A2, in a direction perpendicular to outer edges of the display panel 100, the present invention is not limited thereto, and the light receiving elements 310, 320 and 330 may be disposed closer to the outer edge of the display panel 100, or closer to an outer edge of the display area A1 taken in the plan view of FIG. 1. While the first and third light emitting elements 310 and 330 are disposed closer to one longitudinal edge of the display panel 100, while the second light emitting element 320 is disposed substantially centered in a longitudinal direction of the display panel 100, the present invention is not limited thereto.

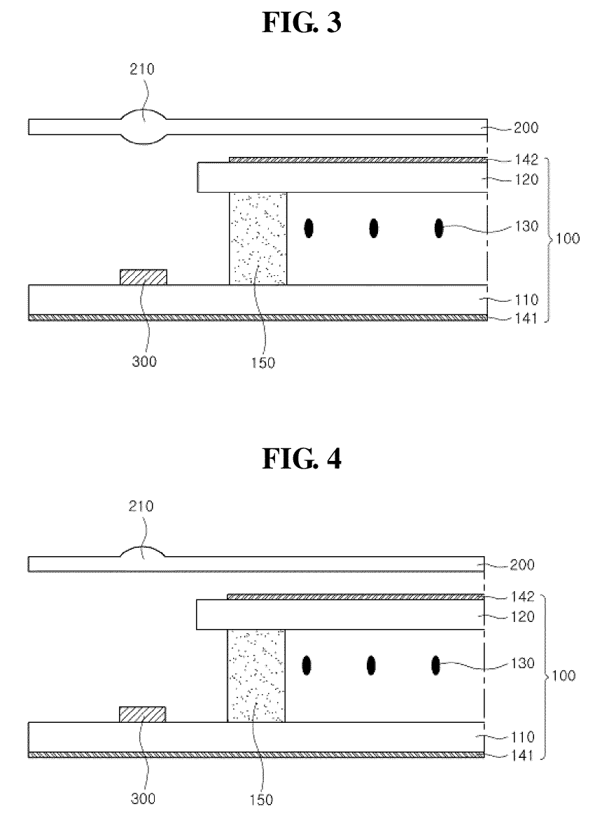

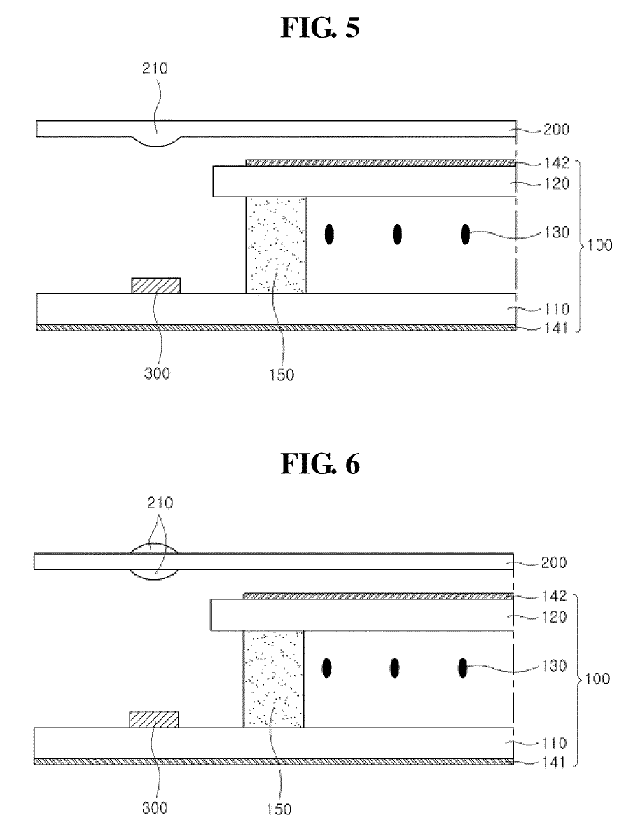

FIG. 2 is a cross-sectional view of an exemplary embodiment of a display panel 100 corresponding to a unit pixel shown in FIG. 1, and FIG. 3 is a cross-sectional view of the display panel 100, taken along the line I-I′ of FIG. 1, in which a protective substrate 200 is also shown in front of the display panel 100 shown in FIG. 1.

Referring to FIGS. 2 and 3, the display panel 100 includes a lower substrate 110, an upper substrate 120 facing the lower substrate 110, a liquid crystal layer 130 disposed between the upper and lower substrates 110 and 120, and first and second polarizing plates 141 and 142 attached to exterior sides of the upper and lower substrates 110 and 120, respectively.

The lower substrate 110 is a transparent substrate including a plurality of thin film transistors (“TFTs”) and a plurality of pixel electrodes 118 arranged substantially in a matrix configuration, and a plurality of gate lines (not shown) and a plurality of data lines (not shown). In one exemplary embodiment, each unit pixel P may be defined including intersections of the gate lines and of the data lines and adjacent areas thereof, a TFT, and/or a pixel electrode 118 are disposed in the each unit pixel P. Alternatively, a storage electrode 112 may further be disposed in the unit pixel P. The TFT includes a gate electrode 111, a gate insulating layer 113, an active layer, a source electrode 115, and a drain electrode 116. In the TFT, the gate electrode 111 is connected to a gate line, the source electrode 115 is connected to a data line, and the drain electrode 116 is connected to the pixel electrode 118. A protecting layer 117 is disposed directly on the gate insulating layer 113, the source electrode 115 and the drain electrode 116.

The pixel electrode 118 and a common electrode 123 disposed on the upper substrate 120 forms a liquid crystal capacitor. The liquid crystal capacitor is charged with a pixel voltage and controls molecular arrangement of the liquid crystal layer 130. The storage electrode 112 and the overlying pixel electrode 118 form a storage capacitor. The storage capacitor enhances the capability of preserving a pixel voltage such that it sustains the pixel voltage filling the pixel electrode 118 until the pixel electrode 118 is charged with the next pixel voltage. The storage electrode 112 is connected to a storage line (not shown) extending substantially parallel with the gate line to be supplied with a reference voltage.

The upper substrate 120 is a light-transmitting substrate in which a light blocking member, e.g., a black matrix, 121 and a red, green, blue (“RGB”) color filter layer 122 are arranged in a matrix configuration. The common electrode 123 may be disposed over the entire surface of the matrix configuration, such as being disposed on a whole of the upper substrate 100.

The black matrix 121 reduces or effectively prevents light leakage between the respective pixel regions, and the RGB color filter layer 122 provides color rendering of the light incident in an opening area of a unit pixel P. Alternatively, an over coat layer (not shown) may further be disposed at a boundary between the RGB color filter layer 122 and the common electrode 123, to improve adhesion and planarity therebetween.

As illustrated in the exemplary embodiment of FIG. 2, a spacer 124 having a predetermined height, taken in a direction substantially perpendicular to a lower surface of the upper substrate 120, may be disposed overlapping with or on the black matrix 121 to maintain a cell gap between the upper and lower substrates 120 and 110. In an alternative embodiment, the spacer 124 may instead be disposed on the lower substrate 110 only, or may be disposed on the lower substrate 110 in addition to the upper substrate 120. While the spacer 124 is illustrated as a substantially columnar or cone elongated shape, the spacer 124 may be replaced by another shape of a spacer member, including but not limited to, a spherical spacer, such as a glass bead.

Referring to FIG. 3, the upper and lower substrates 110 and 120 are coupled to each other, such as by a seal member 150 disposed along an outer perimeter of the display area A1 and outside of the boundary of the display area A1. The display area A1 in FIG. 3 may include an area defined up to an edge (e.g., the leftmost edge in FIG. 3) of the upper substrate 120, such as including the seal member 150. Alternatively, the display area A1 in FIG. 3 may include an area defined up to an edge of the second polarizer 142 and/or an outer edge of the seal member 150, or may include an area only up to an inner edge of the seal member 150, such as excluding the seal member 150. In one exemplary embodiment, the light receiving element 300 may be formed in an area of the display panel 100 where polarizers, the upper substrate 120 and/or the sealing member 150 are not formed.

A liquid crystal layer 130 is disposed between the upper and lower substrates 110 and 120, such as by an injection process and/or a one drop filling process. In an exemplary embodiment, an alignment film (not shown) having a rubbing pattern of a predetermined direction may be disposed on facing surfaces of the upper and lower substrates 110 and 120, respectively, in order to restrict molecular arrangement of the liquid crystal layer 130. The alignment film may be disposed on a lower surface of the upper substrate 120 adjacent to the liquid crystal layer 130, on an upper surface of the lower substrate 110 adjacent to the liquid crystal layer, or on both of the lower surface of the upper substrate 120 and the upper surface of the lower substrate 110.

In the illustrated embodiment of FIG. 3, first and second polarizing plates 141 and 142 are disposed to cover at least the display area A1. The first and second polarizing plates 141 and 142 have polarizing axes, respectively, which are substantially perpendicular to each other, so as to control the output of downwardly incident light in cooperation with the liquid crystal layer 130. In one exemplary embodiment, in an off-mode in which a driving signal is not applied to a unit pixel P, since the linearly polarized light after passing through the first polarizing plate 141 penetrates the liquid crystal layer 130 without a phase change, it is blocked by the second polarizing plate 142 having a polarizing axis perpendicular to that of the first polarizing plate 141. However, in an on-mode in which a driving signal is applied to a unit pixel P, since the linearly polarized light after passing through the first polarizing plate 141 undergoes a perpendicular phase change in the liquid crystal layer 130, it penetrates the second polarizing plate 142 to then be emitted forward. As described above, in the liquid crystal display according to the exemplary embodiment, polarization of incident light is controlled by the first and second polarizing plates 141 and 142 and the amount of light emitted is adjusted based on a phase change by the liquid crystal layer 130. In addition, display of full colors can be implemented using the color filter 122 disposed on the upper substrate 120.

In exemplary embodiments, the light receiving element 300 is preferably provided at an edge of the display panel 100, more specifically, at an edge provided at an outer side of the display area A1 of the display panel 100. The light receiving element 300 may be directly formed on the lower substrate 110 as substantially a same time as when the TFTs are provided on the lower substrate 110, such as during a manufacturing process. Alternatively, after the light receiving element 300 is separately fabricated, it may be mounted on the lower substrate 110 to directly contact the lower substrate 110.

The protective substrate 200 refers to a protective member disposed planarly on the entire outer surface of the display panel 100, such as at the viewing side of the display panel 100. The protective substrate 200 provides a transmission area corresponding to at least the display area A1 of the display panel 100, and protects the display panel 100 against external environments. The protective substrate 200 may include a transparent plastic plate or a transparent glass plate.

Referring again to FIG. 3, a focusing pattern 210 collecting incident light entering the light receiving element 300 is provided at a predetermined region of the protective substrate 200, such as corresponding to a location on the lower substrate 110 where the light receiving element 300 is disposed. As used herein, “corresponding” may define proximate in location and/or similar in dimension or profile.

The focusing pattern 210 in the illustrated embodiment includes at least one convex portion protruding vertically in each of opposite directions in view of the horizontal plane of the protective substrate 200. A first convex portion may extend from a lower surface of the protective substrate 200 towards the lower substrate 110, and a second convex portion may extend from an upper surface of the protective substrate towards the viewing, or front, side of the display panel 100. In a cross-sectional view as illustrated in FIG. 3, the focusing pattern 210 may form a substantially spherical or elliptical shape from the collective protruding convex portions and thickness of the protective substrate 200.

The focusing pattern 210 collects external light (e.g., from the front side of the display panel 100), and provides the collected light to the light receiving element 300, thereby enhancing the sensitivity of the light receiving element 300. Advantageously, in a environment in which external light is relatively very low causing the light receiving element 300 to not operate normally or optimally, even low-sensitivity can be sensed so that luminance of a back light and luminance of displayed images may be increased or decreased using information about the illuminance or luminance detected by the light receiving element.

The focusing pattern 210 can have any of a number of structures, shapes and profiles as long as the structure is configured to collect external light in view of a predetermined position at which the light receiving element 300 is provided, which is to be referred to as a light receiving axis. Various structures of the focusing pattern 210 will now be described in more detail.

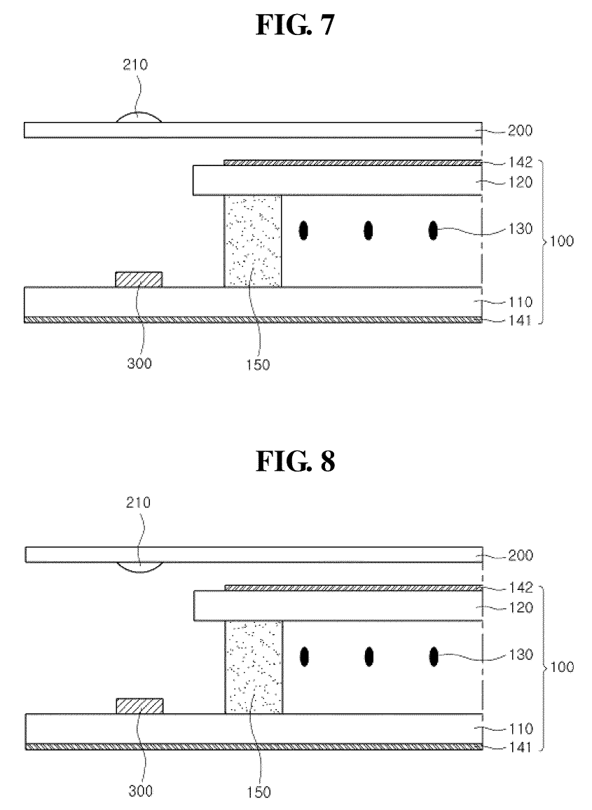

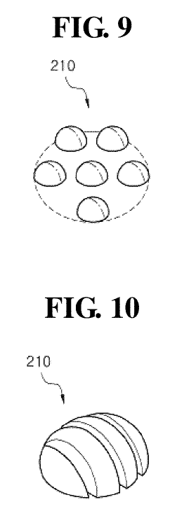

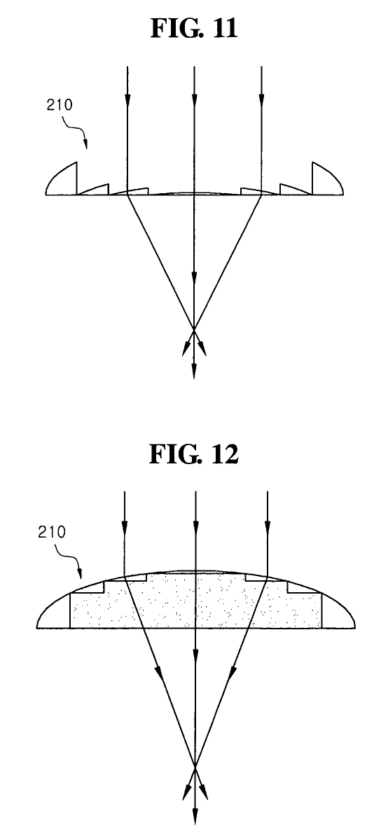

FIGS. 4 through 8 illustrate exemplary embodiments of focusing patterns 210 according to various modifications of the invention shown in FIG. 3, FIGS. 9 and 10 are perspective and partial cross-sectional views illustrating exemplary embodiments of focusing patterns 210 according to various modifications of the invention, and FIGS. 11 and 12 are partial cross-sectional views illustrating focusing patterns 210 according to various modifications of the invention.

Referring to FIGS. 3 through 5, a single focusing pattern 210 is integrally formed with the protective substrate 200, such as through a molding process. The single focusing pattern 210 is disposed corresponding to the light receiving axis relative to the position at which the light receiving element 300 is provided. The focusing pattern 210 of the illustrated exemplary embodiments is a continuous and indivisible part of the protective substrate 200, such that the protective substrate 200 is a single, continuous and indivisible unit including the focusing pattern 210.

A convex portion of the focusing pattern 210 may be configured on at least one of a top surface and a bottom surface of the protective substrate 200, or may be disposed on both of the top and bottoms surfaces of the protective substrate 200. In one exemplary embodiment, as shown in FIG. 3, a convex portion of the focusing pattern 210 may be configured on both the top and bottom surfaces of the protective substrate 200. Alternatively, as shown in FIG. 4, a convex portion of the focusing pattern 210 may be configured only on the top surface of the protective substrate 200. As shown in FIG. 5, a convex portion of the focusing pattern 210 may also be disposed only on the bottom surface of the protective substrate 200.

Referring to FIGS. 6 through 8, the focusing pattern 210 may be formed separately from the protective substrate 200, and then attached or fused to at least one side of the top surface and the bottom surface of the protective substrate 200. The focusing pattern 210 may be removably attached to the protective substrate 200, or may be non-removably attached to the protective substrate 22. As shown in FIG. 6, a convex portion of the focusing pattern 210 may be attached or fused to both the top and bottom surfaces of the protective substrate 200. Alternatively, as shown in FIG. 7, a convex portion of the focusing pattern 210 may be attached or fused only to the top surface of the protective substrate 200. As shown in FIG. 8, a convex portion of the focusing pattern 210 may also be attached or fused only to the bottom surface of the protective substrate 200. In exemplary embodiments, the convex portion separately formed and subsequently attached or fused to the top or and/or bottom surface of the protective substrate 200 is preferably made of transparent resin or transparent glass.

In alternative embodiments, a single the focusing pattern 210 may include a plurality of convex portions on a respective surface of the protective substrate 200, rather than a single convex portion on the respective surface of the protective substrate 200. As shown in FIG. 9, a focusing pattern 210 includes a plurality of convex portions independently formed to collectively define the single focusing pattern 210, providing focusing axes, respectively. As shown in FIG. 10, a single focusing pattern 210 may be separated into a plurality of section, each being itself a convex portion, where the collective single focusing pattern 210 provides a single focusing axis. In an exemplary embodiment, the structure in which a plurality of convex portions provide the respective focusing axes, as shown in FIG. 9, is suitably used when the light receiving element 300 is plurally used. The structure in which a plurality of convex portions provide a single focusing axis, as shown in FIG. 10, is suitably used when the light receiving element 300 is singly used.

In addition, as described above, the convex portion of the focusing pattern 210 may be configured in a biconvex lens structure in which the convex portion is provided on both the top and bottom surfaces of substrate, or a plane convex lens structure in which the convex portion is provided only on one of the top and bottom surfaces of substrate. Alternatively, as shown in FIG. 11, the convex portion of the focusing pattern 210 may be configured in a Fresnel pattern in which in which a plurality of concentric circles are disposed on a surface of the convex portion. The plurality of concentric circles are disposed directly adjacent to each other, and bases of the concentric circles are coplanar with each other and with a respective surface of the protective substrate 200. As shown in FIG. 12, the convex portion of the focusing pattern 210 may be configured in a Fresnel pattern in which a plurality of concentric circles are disposed inside the convex portion. The plurality of concentric circles in FIG. 12 are disposed are disposed in a stacked manner sequentially from a respective surface of the protective substrate 200. Advantageously, the Fresnel pattern enables the convex portion to be substantially planar, thereby minimizing an increase in the thickness due to formation of the focusing pattern 120.

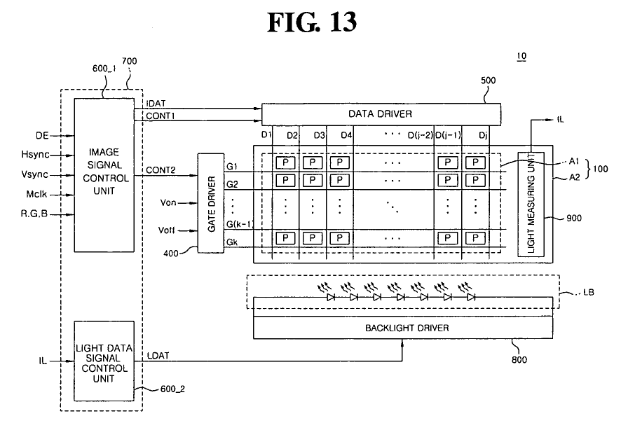

FIG. 13 is a block diagram of an exemplary embodiment of a display device 10 including the display panel 100 and a protective substrate 200 according to the present invention illustrated with reference to FIGS. 1 through 12.

Referring to FIGS. 1 and 13, the display device 10 may include a display panel 100 including a display area A1, and a non-display area A2 defined therein, a signal controller 700 including an image signal control unit 600_1 and a light data signal control unit 600_2, a gate driver 400, a data driver 500, a backlight driver 800, and a light-emitting block LB connected to the backlight driver 800.

The display panel 100 may include a light measuring unit 900 including at least one light receiving element 300 provided in the non-display area A2. The light measuring unit 900 measures external illuminance IL sensed by the light receiving element 300 and transmits the measured external illuminance IL to the signal controller 700.

The signal controller 700 may convert first image signals R, G and B into second image signals IDAT and output the same. In addition, the signal controller 700 may receive external control signals Vsync, Hsync, Mclk, and DE, for controlling display of the first image signals R, G and B, and output a data control signal CONT1 and a gate control signal CONT2. Further, the signal controller 700 may receive external illuminance IL supplied from the light measuring unit 900, and supply a light data signal LDAT corresponding to the external illuminance IL to the backlight driver 800.

The signal controller 700 may be functionally divided into an image signal control unit 600_1 and a light data signal control unit 600_2. The image signal control unit 600_1 controls images displayed on the display panel 100, while the light data signal control unit 600_2 controls the operation of the backlight driver 800. The image signal control unit 600_1 and the light data signal control unit 600_2 may be physically separated from each other, or may be integrally formed into a single and continuous unit.

The image signal control unit 600_1 receives first image signals R, G and B and outputs second image signals IDAT corresponding to the received first image signals R, G and B. The second image signals IDAT may be signals converted from the first image signals R, G and B for improving display quality, for example, overdriving. A detailed explanation about the operation of overdriving will not be given herein.

The image signal control unit 600_1 may also receive external control signals Vsync, Hsync, Mclk, and DE, and generate a data control signal CONT1 and a gate control signal CONT2. The external control signals include, but are not limited to, a vertical synchronization signal Vsync, a horizontal synchronization signal Hsync, a main clock signal MCLK, and a data enable signal DE. The data control signal CONT1 is used to control the operation of the data driver 500, and the gate control signal CONT2 is used to control the operation of the gate driver 400.

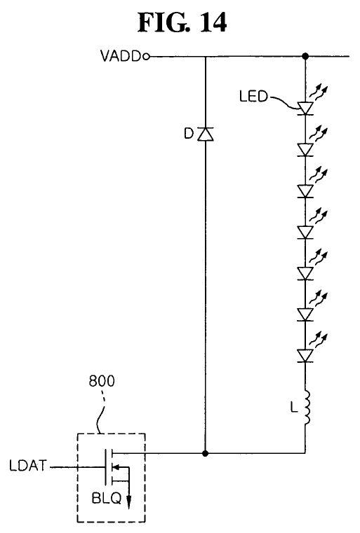

The light data signal control unit 600_2 receives external illuminance IL supplied from the light measuring unit 900, and provides a light data signal LDAT corresponding to the external illuminance IL to the backlight driver 800. The providing of the light data signal LDAT corresponding to the external illuminance IL may be performed by adjusting a duty ratio of the light data signal LDAT through, for example, a pulse width modulation (“PWM”) technique. In one exemplary embodiment, if the external illuminance IL is high, a pulse width of the light data signal LDAT is increased. On the other hand, if the external illuminance IL is low, a pulse width of the light data signal LDAT is decreased. The PWM technique and the controlling operation of luminance of back light supplied from the light-emitting block BL will later be described with reference to FIG. 14.

The gate driver 400, provided with the gate control signal CONT2 from the image signal control unit 600_1, applies a gate signal to the gate lines G1-Gk. Here, the gate signal includes a combination of a gate-on voltage Von and a gate-off voltage Voff, which are generated from a gate on/off voltage generator (not shown). The gate control signal CONT2 for controlling the operation of the gate driver 400 includes a vertical synchronization start signal instructing start of the operation of the gate driver 400, a gate clock signal controlling an output timing of the gate on signal, an output enable signal that determines a pulse width of the gate-on voltage Von, etc.

The data driver 500 receives the data control signal CONT1 from the image signal control unit 600_1 and applies voltages corresponding to the second image signals IDAT to the data lines D1-Dj. The voltages corresponding to the second image signals IDAT may be supplied from a gray voltage generator (not shown) according to grayscales of the second image signals IDAT. The data control signal CONT1 includes signals for controlling the operation of the data driver 500. The signals for controlling the operation of the data driver 500 include a horizontal synchronization start signal for starting the operation of the data driver 500, an output enable signal that determining the output of an image data voltage, etc.

The backlight driver 800 adjusts luminance of back light supplied from a light-emitting block LB in response to a light data signal LDAT. The luminance of back light supplied from a light-emitting block LB may vary according to a duty ratio of the light data signal LDAT. The internal structure and operation of the backlight driver 800 will later be described in more detail with reference to FIG. 14.

The light-emitting block LB includes at least one light source and provides back light to the display panel 100. In an exemplary embodiment, the light-emitting block LB may include a point light source, such as a light-emitting diode (“LED”), as shown. Alternatively, the light source may be a line light source, or a surface light source. The luminance of back light supplied from a light-emitting block LB may be controlled by the backlight driver 800 connected to the light-emitting block LB.

FIG. 14 is a circuit diagram illustrating the backlight driver 800 and a light-emitting block LB shown in FIG. 13.

Referring to FIG. 14, the backlight driver 800, including a switching element BLQ, controls luminance of the light-emitting block LB in response to the light data signal LDAT.

The backlight driver 800 operates as follows. When the light data signal LDAT is activated to a high level, the switching element BLQ of the backlight driver 800 is turned on and a power supply voltage Vin is supplied to the light-emitting block LB. Accordingly, current flows through the light-emitting block LB and an inductor L. Here, the inductor L stores the energy derived from the current. When the light data signal LDAT is deactivated to a low level, the switching element BLQ is turned off, creating a closed circuit constituted by the light-emitting block LB, the inductor L, and a diode D, so that current flows therethrough. As the energy stored in the inductor L is discharged, the quantity of current is reduced.

As described above, a time taken for the switching element BLQ to be turned on is adjusted according to the duty ratio of the light data signal LDAT, thereby controlling the luminance of the light-emitting block LB. The duty ratio of the light data signal LDAT can be adjusted through PWM in response to external illuminance IL. In other words, if the external illuminance IL is high, a pulse width of the light data signal LDAT is increased, while if the external illuminance IL is low, a pulse width of the light data signal LDAT is decreased. Accordingly, if an ambient condition is bright, the luminance of back light is increased, while if an ambient condition is dark, the luminance of back light is reduced.

As described above, the luminance of displayed images is controlled by adjusting the luminance of back light according to external illuminance IL, such as, illuminance of an ambient condition, thereby improving display quality. A deterioration in the display quality may result from unduly high luminance of displayed images, compared to the external illuminance, causing glare, and too low luminance, degrading readability. Exemplary embodiments of the present invention are configured such that the luminance of back light can be actively adjusted in response to according to luminance of an ambient condition, thereby advantageously reducing power consumption.

In exemplary embodiments of the display device according to the present invention, a protective substrate is disposed in front (e.g., viewing side) of a display panel including a light receiving element and focusing patterns are disposed on the protective substrate to improve sensitivity of the light receiving element. Advantageously, a slight change in the luminance of an ambient condition may be detected relatively rapidly and accurately, and actively control luminance of a displayed image.

In the exemplary embodiments, since the same sensitivity as that of a high-cost light receiving element is attained even with use of an intermediate- and low-cost light receiving element, the manufacturing cost can be advantageously reduced.

Further, in exemplary embodiments, since the luminance of displayed images is actively controlled in response to a slight change in the luminance of an ambient condition, further improving display quality and reducing power consumption.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the illustrated embodiments be considered in all respects as illustrative and not restrictive, reference being made to the appended claims rather than the foregoing description to indicate the scope of the invention.

What is claimed is:

1. A display device comprising:
a display panel including a display area and a non-display area; and
a protective substrate disposed on a viewing side of the display panel,
wherein at least one light receiving element is disposed in the non-display area, and a focusing pattern is disposed on the protective substrate corresponding to a location at which the light receiving element is disposed.

2. The display device of claim 1, wherein the focusing pattern includes at least one convex portion.

3. The display device of claim 2, wherein the convex portion includes one configuration of both surfaces of the convex portion are convexly disposed, only one surface of the convex portion is convexly disposed, and a Fresnel pattern is disposed on a surface of the convex portion.

4. The display device of claim 2, wherein the convex portion is continuous and indivisible with the protective substrate.

5. The display device of claim 2, wherein the convex portion is formed separately from the protective substrate, and attached or fused to at least one of a top surface and a bottom surface of the protective substrate.

6. The display device of claim 1, wherein the focusing pattern includes a plurality of convex portions independently formed and providing focusing axes, respectively.

7. The display device of claim 1, wherein the focusing pattern includes a single convex portion including a plurality of separated sections, and providing a single focusing axis.

8. The display device of claim 1, wherein the protective substrate is a transparent member.

9. The display device of claim 8, wherein the transparent member is a transparent plastic plate or a transparent glass plate.

10. A display device comprising:
a display panel comprising:
a display area and a non-display area defined therein, and
a light measuring unit including at least one light receiving element disposed in the non-display area and sensing an illuminance external to the display panel;
a protective substrate disposed in a viewing side of the display panel, and including a focusing pattern disposed at a predetermined region of the protective substrate corresponding to a light receiving axis of the light receiving element; and
a light-emitting block supplying back light to the display panel, such that the luminance of the back light is adjusted in response to the external illuminance sensed by the light receiving element.

11. The display device of claim 10, wherein the focusing pattern includes at least one convex portion.

12. The display device of claim 11, wherein the convex portion includes at least one configuration of both surfaces of the convex portion are convexly disposed, only one surface of the convex portion is convexly disposed, a Fresnel pattern is disposed on a surface of the convex portion.

13. The display device of claim 10, wherein if the external illuminance is high, the luminance of back light is increased, while if the external illuminance is low, the luminance of back light is reduced.

14 The display device of claim 10, further comprising:
a backlight driver controlling the luminance of the light-emitting block; and
a light data signal control unit supplying a light data signal to the backlight driver,
wherein a pulse width of the light data signal is adjusted according to the external illuminance.

15. The display device of claim 14, wherein if the external illuminance is high, a pulse width of the light data signal is increased, and if the external illuminance is low, a pulse width of the light data signal is decreased.
